(19) United States
(12) Patent Application Publication
(10) Pub. No.: US 2021/0356246 A1
(43) Pub. Date: Nov. 18, 2021

(54) OPERATOR TERMINAL FOR BLASTING SYSTEM

(71) Applicant: HANWHA CORPORATION, Seoul (KR)

(72) Inventors: Tae Seob Shin, Boeun-gun (KR); Ki Woong Park, Boeun-gun (KR); Doo Hyun Lee, Boeun-gun (KR); Ki Chul Park, Boeun-gun (KR)

(73) Assignee: HANWHA CORPORATION, Seoul (KR)

(21) Appl. No.: 16/627,687

(22) PCT Filed: Dec. 16, 2019
(86) PCT No.: PCT/KR2019/017762

§ 371 Date: Dec. 30, 2019

(30) Foreign Application Priority Data
Dec. 28, 2018 (KR) 10-2018-0172033

(51) Int. Cl. F42D 1/045; H04Q 9/00

(52) U.S. Cl. CPC F42D 1/045; H04Q 2209/40; H04Q 2209/30; H04Q 9/00

(57) ABSTRACT

Provided is an operator terminal for a blasting system. The terminal includes a logging unit that acquires detonation information on a detonator using a logging scheme, a scanning unit that acquires the detonation information using a scanning scheme, and a control unit that receives the detonation information, matches the detonation information and design information to each other, and transfers setting information corresponding to the detonation information to the detonator. The logging scheme is a scheme of acquiring the detonation information through a detonation wire connected to the detonator, and the scanning scheme is a scheme of capturing an identification image and thus acquiring the detonation information.

### TECHNICAL FIELD

Embodiments of the present invention relate to an operator terminal for a blasting system and, more particularly, to an operator terminal that is capable of acquiring detonation information from a detonator by using one scheme among a scanning scheme and a logging scheme in a selective manner.

### BACKGROUND ART

In general, explosives are used for blasting of rock, demolition of buildings not in use, and the like in construction sites. That is, a blasting target is sectionalized, multiple holes are drilled in the resulting sections of the blasting target, explosives are inserted into the respective drilled holes, and the explosives are connected to a blasting system. The explosives are detonated by operating a blasting system, and thus the blasting target is blasted.

The blasting system is configured to include a blasting cap that serves as a triggering device to detonate an explosive and a blasting apparatus that transfers electric power necessary for operating the detonating cap and a command to the detonating cap. At this time, an electric blasting cap is mainly used as a blasting cap for the blasting system. The electric blasting cap is installed on the explosive side, and multiple electric blasting caps are connected to one blasting apparatus.

Structures of the electric blasting caps come in two types: one structure in which, when a command is transferred from a blasting apparatus, multiple electric blasting caps connected to the blasting apparatus operate at the same time, thereby detonating explosives at the same time; and the other structure in which multiple electric blasting caps are set to different delay times, respectively, and thus the multiple electric blasting caps operate sequentially, thereby detonating explosives sequentially.

Multiple blasting caps that detonate multiple explosives at the same time are mainly used in the related art. However, in recent years, multiple electric blasting caps that sequentially detonate multiple explosives have been mainly used. Examples of a document in which a blasting system using an electric blasting cap is disclosed include Korean Patent Nos. 10-1016538, 10-0665878, 10-0665880, and 10-0733346, and Japanese Application Publication No. 2005-520115.

### DISCLOSURE

### Technical Problem

An objective of the present invention is to provide an operator terminal for a blasting system that is capable of acquiring detonation information from a denotator using one of a scanning scheme and a logging scheme in a selective manner.

### Technical Solution

In order to accomplish the above objective, according to an aspect of the present invention, there is provided an operator terminal for a blasting system, the terminal including: a logging unit that acquires detonation information on a detonator using a logging scheme; a scanning unit that acquires the detonation information using a scanning scheme; and a control unit that receives the detonation information, matches the detonation information and design information to each other, and transfers setting information corresponding to the detonation information to the detonator, in which the logging scheme is a scheme of acquiring the detonation information through a detonation wire connected to the detonator, and in which the scanning scheme is a scheme of capturing an identification image and thus acquiring the detonation information.

In the operator terminal according to the aspect, the logging unit may be connected to a connector that connects the detonation wire and a central wire.

In the operator terminal according to the aspect, in a case where the control unit receives the detonation information from the logging unit, the control unit may transfer the setting data corresponding to the detonation information to the detonator.

In the operator terminal according to the aspect, in a case where the control unit receives the detonation information from the scanning unit, the control unit may store the setting data corresponding to the detonation information.

In the operator terminal according to the aspect, the detonator may transfer to the control unit a detonator connection signal indicating that the detonator and the operator terminal are connected to each other, and in response to the detonator connection signal, the control unit may transfer the setting data to the detonator.

In the operator terminal according to the aspect, the control unit may be connected to the detonator through a wireless network.

In the operator terminal according to the aspect, the control unit may be connected to the detonator through a wired network.

In the operator terminal according to the aspect, the identification information an image that is attached on an identification tag coupled to the detonation wire.

In the operator terminal according to the aspect, the identification image may be a barcode or a QR code.

### Advantageous Effects

An operator terminal for a blasting system according to an embodiment of the present invention can acquire detonation information from a detonator using one of a scanning scheme and a logging scheme in a selective manner.

In addition, the operator terminal for a blasting system according to the embodiment of the present invention can perform a blasting job using a scheme desired by an operator.

In addition, the operator terminal for a blasting system according to the embodiment of the present invention can correct an error in the blasting job quickly and easily.

Advantages that are obtained according to the present invention are not limited to those described above, and from the following description, advantages that are not described above will be clearly understood by a person of ordinary skill in the art.

### BRIEF DESCRIPTION OF DRAWINGS

FIGS. 1 and 2 are diagram each illustrating an operator terminal according to an embodiment of the present invention;

FIG. 3 is a diagram illustrating an operator terminal according to an embodiment of the present invention;

FIG. 4 is a diagram illustrating a logging unit of the operator terminal according to the embodiment of the present invention;

FIG. 5 is a diagram illustrating a scanning unit of the operator terminal according to the embodiment of the present invention;

FIG. 6 is a diagram illustrating a method of operating the operator terminal according to an embodiment of the present invention; and

FIG. 7 is a diagram illustrating the method of operating the operator terminal according to the embodiment of the present invention.

### DESCRIPTION OF THE REFERENCE NUMERALS IN THE DRAWINGS

| | |
|---|---|
| 10: blasting system | 100: operator terminal |
| 110: logging unit | 120: scanning unit |
| 130: control unit | 140: storage unit |
| 200: detonator | 300: detonation wire |
| 400: central wire | 500: connector |
| 600: identification tag | 700: wireless network |

### MODE FOR INVENTION

Embodiments of the present invention and other matters necessary for a person of ordinary skill in the art to get an easy understand of the contents of the present invention will be described in detail below with reference to the accompanying drawings. However, embodiments of the present invention will be described below only for the purpose of illustration, regardless of how they are described, and therefore, various other embodiments can be implemented within the scope of the present invention defined in the claims.

The same reference character refers to the same element. In addition, for effective description of the technical contents, thicknesses, ratios, and dimensions of constituent elements are expressed in an exaggerated manner in the drawings. The expression “and/or” is used to include one or more combinations that are defined by relevant constituents.

Although the terms first, second and so on are used to describe various constituent elements, but should not impose any limitation on the meanings of the constituent elements. These terms are generally used only to distinguish one element from another. For example, a first constituent element may be expressed as a second constituent element without departing from the scope of the present invention. In the same manner, the second constituent element may also be expressed as the first constituent element. An expression in the singular may be construed as that in the plural, except as otherwise distinctively expressed in context.

In addition, the terms, “under”, “below”, “over”, “above” and so on are used to describe constituents that are illustrated in the drawings. These terms are relative in conception and are described with reference to directions indicated in the drawings.

It should be understood that the term “include”, “have”, or the like is intended to indicate that a feature, a number, a step, an operation, a constituent element, a component, or a combination of these, which is described in the present specification, is present. Therefore, it should be understood that the term does not negate in advance the likelihood that one or more other features, numbers, steps, operations, constituent elements, components, or combinations of these will be present and added.

That is, the present invention is not limited to embodiments that will be disclosed below, and can be implemented into various other embodiments. When a certain constituent is described below as being connected to any other constituent, a direct connection between these constituents and an electrical connection between these constituents with any other element in between exist. In addition, it should be noted that, although the same constituent elements are indicated otherwise in the drawings, they are indicated by the same reference numerals and characters, as far as is possible.

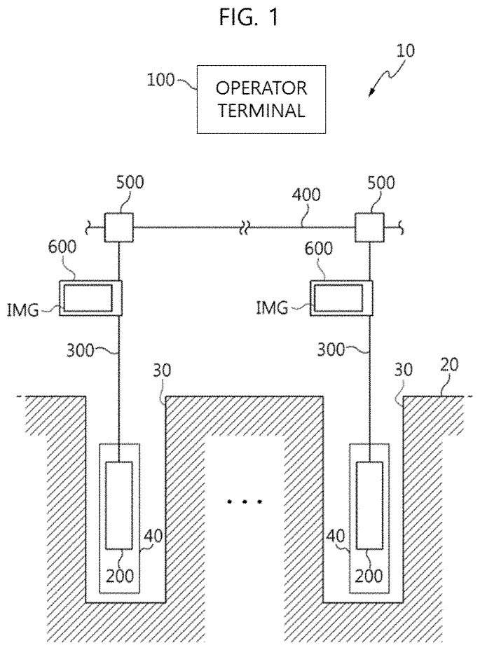

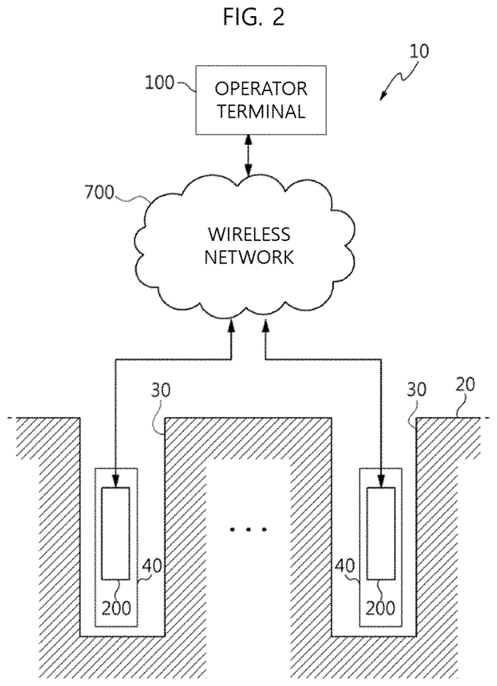

FIGS. 1 and 2 are diagrams each illustrating a blasting system 10 according to an embodiment of the present invention.

The blasting system 10 includes an operator terminal 100, a detonator 200, a detonation wire 300, a central wire 400, a connector 500, an identification tag 600, and a wireless network 700.

In order to blast a blasting target 20, an operator who performs blasting drills blasting holes 30 in the blasting target 20. The operator inserts explosives 40, to each of which the detonator 200 is attached, into multiple blasting holes 30, respectively. At this time, the operator performs a blasting job while having the operator terminal 100 with himself/herself.

Subsequently, in a state where a blasting machine (not illustrated) and the detonator 200 are not connected with each other, the operator extracts detonation information from the detonator 200 using the operator terminal 100.

According to an embodiment of the present invention, the operator terminal 100 acquires the detonation information from the detonator 200 using one of a scanning scheme and a logging scheme.

In the present specification, the logging scheme means a scheme of acquiring the detonation information directly from the detonation wire 300 connected to the detonator 200.

In the present specification, the scanning scheme means a scheme of capturing an identification image IMG attached on the identification tag 600 coupled to the detonation wire 300 connected to the detonator 200 and thus acquiring the detonation information. For example, the identification IMG is a barcode or a QR code.

The operator terminal 100 extracts an ID, a type, performance, a delay time, and the like of the detonator 200 from the detonation information.

The operator terminal 100 matches the detonation information to design information. For example, the design information includes IDs of the detonators indicated on a blasting map, and a position and setting data (for example, the delay time, or the like) that correspond to each of the IDs. According to an embodiment, the operator terminal 100 stores in advance the design information that is created at the time of developing a design for blasting.

According to a result of the matching, the operator terminal 100 transfers setting data corresponding to the detonation information to the detonator 200.

The operator terminal 100 and the detonator 200 perform communication with each other through a wired network or the wireless network 700. For example, the operator terminal 100 and the detonator 200 perform communication with each other through a wired network that is realized by the detonation wire 300, the central wire 400, and the connector 500.

The detonation wire 300 is a wire that is connected to the detonator 200 and extends, along the blasting hole 30 into which the detonator 200 is installed, to the outside. The connector 500 connects the detonation wire 300 and the central wire 400 to each other. That is, although not illustrated in FIG. 1, the operator terminal 100 is connected to the central wire 400, and the detonator 200 performs communication with the operator terminal 100 through the wired network or the wireless network 700.

The detonator 200 transfers a detonator connection signal to the operator terminal 100. At this time, the detonator connection signal is a signal that indicates that the detonator 200 and the operator terminal 100 are connected to each other. The operator terminal 100 receives the detonator connection signal and thus acknowledges that the operator terminal 100 is connected to the detonator 200. In response to the detonator connection signal, the operator terminal 100 transfers design data to the corresponding detonator 200.

In order to start blasting, the operator operates the operator terminal 100 or a blasting apparatus (not illustrated) and thus generates a blasting command. Then, the operator terminal 100 or the blasting apparatus (not illustrated) transfers the blasting command including the delay time to the detonator 200. The blasting command includes the delay time corresponding to the detonator 200. The detonator 200 starts to count the delay time. When counting of a preset delay time is finished, the detonator 200 detonates the connected explosive 40. Therefore, multiple explosives 40 are blasted at the same time or sequentially according to the delay time, and thus the blasting targets 20 are blasted.

According to an embodiment, the wireless network 700 is realized as a mobile radio communication network in Long Term Evolution (LTE) or as a wireless network of any type that complies with Bluetooth, Bluetooth Low Energy (BLE), Zigbee, Thread, WiFi, Wireless Broadband Internet (Wibro), or LoRa.

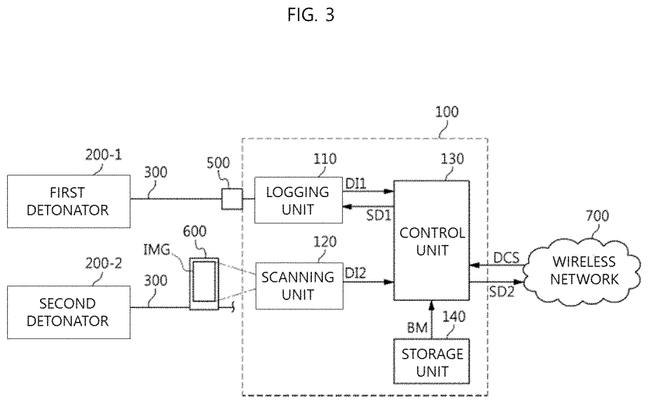

FIG. 3 is a diagram illustrating the operator terminal 100 according to an embodiment of the present invention. FIG. 3 illustrates a first detonator 200-1 and a second detonator 200-2 together for convenience in description.

With reference to FIG. 3, the operator terminal 100 includes a logging unit 110, a scanning unit 120, a control unit 130, and storage unit 140.

The logging unit 110 acquires first detonation information DI1 on the first detonator 200-1 from the first detonator 200-1 using the logging scheme. The logging scheme here is a scheme in which the operator terminal 100 is connected to the connector 500 that connects the detonation wire 300 connected to the detonator and the central wire 400 and in which the detonation information is thus acquired through the detonation wire 300. The logging unit 110 transfers the acquired first detonation information DI1 to the control unit 130.

The scanning unit 120 acquires second detonation information DI2 on the second detonator 200-2 from the second detonator 200-2 using the scanning scheme. The scanning scheme here is a scheme in which the operator terminal 100 captures the identification image IMG attached on the identification tag 600 coupled to the detonation wire 300 connected to the detonator and in which the detonation information is thus acquired. The scanning unit 120 transfers the acquired second detonation information DI2 to the control unit 130.

The control unit 130 retrieves design information BM from the storage unit 140. The design information BM here includes the IDs of the detonators indicated on the blasting map, and the position and the setting data (for example, the delay time, or the like) that correspond to each of the IDs.

The control unit 130 receives the first detonation information DI1 from the logging unit 110. The control unit 130 matches the first detonation information DI1 to the design information BM. Therefore, the control unit 130 extracts first setting data SD1 corresponding to the first detonation information DI1 from the design information BM. The control unit 130 transfers the first setting data SD1 to the first detonator 200-1 through the logging unit 110. That is, the first setting data SD1 is transferred to the first detonator 200-1 through the logging unit 110 and the detonation wire 300.

The control unit 130 receives the second detonation information DI2 from the scanning unit 120. The control unit 130 matches the second detonation information DI2 to the design information BM. Therefore, the control unit 130 extracts second setting data SD2 corresponding to the second detonation information DI2 from the design information BM. The control unit 130 waits to receive the detonator connection signal DCS from the second detonator 200-2 and stores the second setting data SD2.

The control unit 130 receives the detonator connection signal DCS from the second detonator 200-2. For example, the control unit 130 receives the detonator connection signal DCS from the second detonator 200-2 through the wired network or the wireless network 700. FIG. 3 illustrates that, as an example, the detonator connection signal DCS is received through the wireless network 700. However, the present invention is not limited to this, and according to an embodiment, the control unit 130 receives the detonator connection signal DCS from the second detonator 200-2 through the wired network that includes the detonation wire 300, the central wire 400, and the connector 500.

In response to the detonator connection signal DCS, the control unit 130 transfers the second setting data SD2 to the second detonator 200-2 through the wireless network 700. That is, the second setting data SD2 is transferred to the second detonator 200-2 through the wireless network 700.

According to an embodiment, the control unit 130 is realized as a central processing unit (CPU), a micro processing unit (MPU), a graphic processing unit (GPU), a micro controller unit (MCU), or the like.

The storage unit 140 stores the design information BM. For example, the design information BM is on details of blasting that are already designed, and includes the IDs of the detonators indicated on the blasting map, and the position and the setting data (for example, the delay time, or the like) that correspond to each of the IDs.

According to an embodiment, the storage unit 140 is realized as a read only memory (ROM), a random access memory (RAM), a hard disk drive (HDD), or a solid state drive (SDD), or the like.

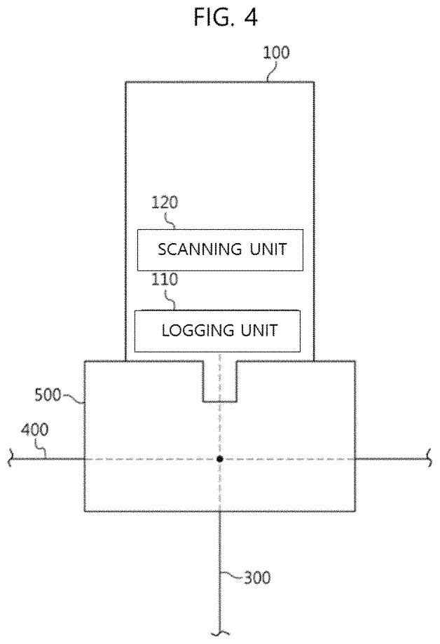

FIG. 4 is a diagram illustrating the logging unit 110 of the operator terminal 100 according to the embodiment of the present invention.

With reference to FIG. 4, the operator terminal 100 includes the logging unit 110 and the scanning unit 120.

The logging unit 110 acquires the detonation information from the detonator using the logging scheme. That is, the logging unit 110 is connected to the connector 500 and is connected to the detonation wire 300 connected to the detonator. According to an embodiment, the logging unit 110 and the connector 500 are formed to be connected to each other. At this time, the detonation wire 300 and the central wire 400 are connected to each other in the connector 500.

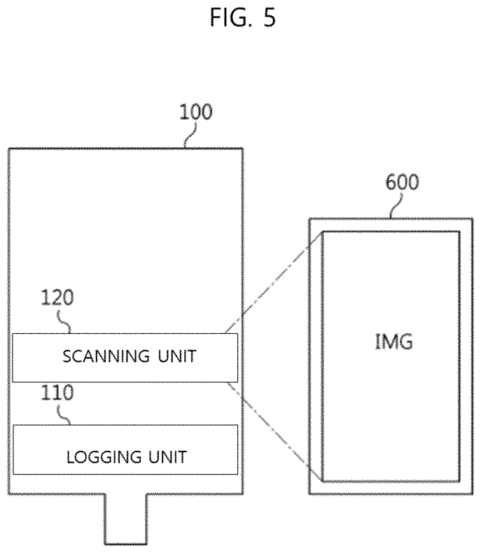

FIG. 5 is a diagram illustrating the scanning unit 120 of the operator terminal 100 according to the embodiment of the present invention.

With reference to FIG. 5, the operator terminal 100 includes the logging unit 110 and the scanning unit 120.

The scanning unit 120 acquires the detonation information from the detonator 200 using the scanning scheme. That is, the scanning unit 120 includes a scanner. The scanning unit 120 acquires the detonation information by scanning the identification image IMG.

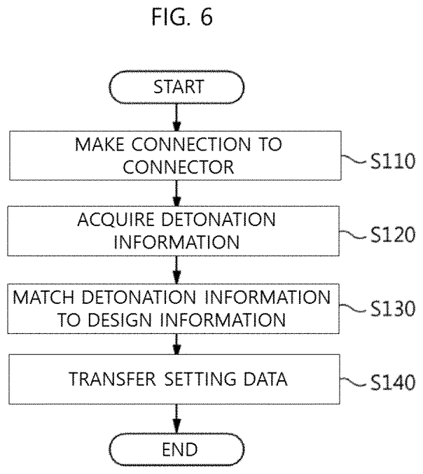

FIG. 6 illustrates a method of operating the operator terminal 100 according to an embodiment of the present invention. FIG. 6 illustrates the method of operating the operator terminal 100 in a case where the detonation information is received using the logging scheme.

With reference to FIGS. 1 to 6, the operator terminal 100 is connected to the connector 500 (S110). That is, the logging unit 110 of the operator terminal 100 is connected to the connector 500 and thus is connected to the detonation wire 300 connected to the detonator 200.

The operator terminal 100 acquires the detonation information (S120). That is, the logging unit 110 of the operator terminal 100 acquires the detonation information on the detonator 200 from the detonation wire 300.

The operator terminal 100 matches the detonation information to the design information BM (S130). That is, the control unit 130 of the operator terminal 100 matches the detonation information on the detonator 200 to the design information BM stored in the storage unit 140.

The operator terminal 100 transfers the setting data corresponding to the detonation information to the detonator 200 (S140). That is, according to the result of the matching, the control unit 130 transfers the setting data corresponding to the detonation information to the detonator 200. At this time, the setting data is transferred to the detonator 200 through the logging unit 110 and the detonation wire 300.

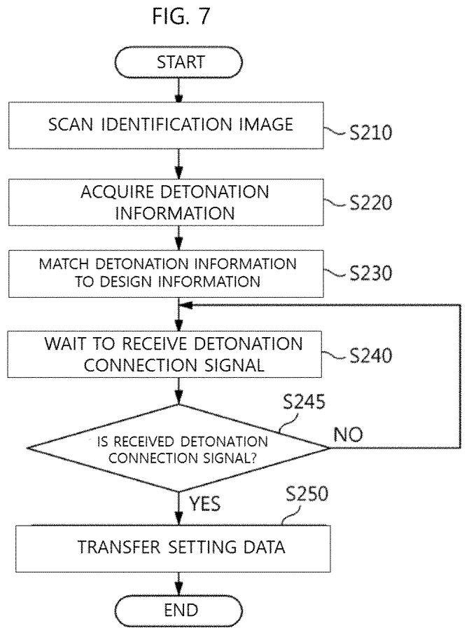

FIG. 7 illustrates the method of operating the operator terminal 100 according to the embodiment of the present invention. FIG. 7 illustrates the method of operating the operator terminal 100 in a case where the detonation information is received using the scanning scheme.

With reference to FIGS. 1 to 7, the operator terminal 100 scans the identification image IMG (S210). That is, the scanning unit 120 of the operator terminal 100 scans the identification image IMG of the detonation wire 300 connected to the detonator 200. At this time, the identification image IMG is a barcode or a QR code.

The operator terminal 100 acquires the detonation information (S220). That is, the scanning unit 120 of the operator terminal 100 scans the identification image IMG and thus acquires the detonation information on the detonator 200.

The operator terminal 100 matches the detonation information to the design information BM (S230). That is, the control unit 130 of the operator terminal 100 matches the detonation information on the detonator 200 to the design information BM stored in the storage unit 140.

The operator terminal 100 waits to receive the detonator connection signal DCS (S240). That is, according to the result of the matching, the control unit 130 of the operator terminal 100 extracts and stores the design data. Then, the control unit 130 waits to receive the detonator connection signal DCS from the detonator 200.

In a case where the detonator connection signal DCS is received (S245), the operator terminal 100 transfers the setting data to the detonator 200 (S250). For example, the control unit 130 receives the detonator connection signal DCS from the detonator 200 through the wired network or the wireless network. In a case where the detonator connection signal DCS is received, the control unit 130 transfers the setting data to the detonator 200.

According to an embodiment, in a case where, after the entire job is finished, a problem occurs in a specific detonator 200, the operator terminal 100 acquires the detonation information on the specific detonator 200 using the scanning unit 120. Therefore, the detonator 200 in which the problem occurs is quickly identified.

As described above, an operator terminal for a blasting system according to an embodiment of the present invention acquires detonation information from a detonator using one of a scanning scheme and a logging scheme in a selective manner.

In addition, the operator terminal for a blasting system according to the embodiment of the present invention performs a blasting job using a scheme desired by an operator.

In addition, the operator terminal for a blasting system according to the embodiment of the present invention corrects an error in the blasting job quickly and easily.

The desirable embodiments of the present invention are described above, and it will be clearly understood by a person of ordinary skill in the art that various modifications or alterations to the embodiments can be made within the technical idea and scope of the present invention that is defined in the following claims.

Therefore, the technical scope of the present invention is not limited to the detailed description in the specification and should be defined in the claims.

1. An operator terminal for a blasting system, the terminal comprising:
a logging unit that acquires detonation information on a detonator using a logging scheme;
a scanning unit that acquires the detonation information using a scanning scheme; and
a control unit that receives the detonation information, matches the detonation information and design information to each other, and transfers setting information corresponding to the detonation information to the detonator, wherein the logging scheme is a scheme of acquiring the detonation information through a detonation wire connected to the detonator, and the scanning scheme is scheme of capturing an identification image and thus acquiring the detonation information.

2. The operator terminal according to claim 1, wherein the logging unit is connected to a connector that connects between the detonation wire and a central wire.

3. The operator terminal according to claim 1, wherein in a case where the control unit receives the detonation information from the logging unit, the control unit transfers the setting data corresponding to the detonation information to the detonator.

4. The operator terminal according to claim 1, wherein in a case where the control unit receives the detonation information from the scanning unit, the control unit stores the setting data corresponding to the detonation information.

5. The operator terminal according to claim 4, wherein the detonator transfers to the control unit a detonator connection signal indicating that the detonator and the operator terminal are connected to each other, and in response to the detonator connection signal, the control unit transfers the setting data to the detonator.

6. The operator terminal according to claim 5, wherein the control unit is connected to the detonator through a wireless network.

7. The operator terminal according to claim 5, wherein the control unit is connected to the detonator through a wired network.

8. The operator terminal according to claim 1, wherein the identification information is an image that is attached on an identification tag coupled to the detonation wire.

9. The operator terminal according to claim 1, wherein the identification image is a barcode or a QR code.
